(19) United States
(12) Patent Application Publication
(10) Pub. No.: US 2012/0102469 A1
(43) Pub. Date: Apr. 26, 2012

(54) DETERMINISTIC APPLICATION BREAKPOINT HALTING BY LOGICALLY RELATING BREAKPOINTS IN A GRAPH

(75) Inventors: Sandhya Kapoor, Austin, TX (US); Lohith Ravi, Bangalore (IN)

(73) Assignee: INTERNATIONAL BUSINESS MACHINES CORPORATION, Armonk, NY (US)

(21) Appl. No.: 12/910,048

(22) Filed: Oct. 22, 2010

(51) Int. Cl. G06F 9/44

(52) U.S. Cl. 717/129

(57) ABSTRACT

An operating system or virtual machine of an information handling system (IHS) initializes a debugger tool for breakpoint management of an application during debugging operations. The operating system or virtual machine initializes a directed acyclic graph (DAG) tool that employs a graphical user interface (GUI) or command line interface (CLI) for breakpoint generation and manipulation. A programmer generates breakpoints and breakpoint conditions that support the debug of application software during design, development and test. The programmer constructs one or more DAGs for use by the debugger and DAG tool. The programmer initializes the application for debugging operations. When the debugger encounters a breakpoint, the DAG tool interprets the breakpoint. If the encountered breakpoint is part of any DAG, the DAG tool determines eligibility for the encountered breakpoint to either break or not break depending on the rules of the DAG construct. The programmer may modify and add new breakpoints during debug and runtime operations of the application.

### BACKGROUND

The disclosures herein relate generally to information handling systems (IHSS), and more specifically, to the management of program application breakpoints in an IHS.

Information handling systems (IHSS) typically employ operating systems that execute applications or other processes that may require the resources of multiple processors or processor cores. IHSS may employ virtual machine (VM) technology such as that which the JAVA Development Kit (JDK) or JAVA Runtime Environment (JRE) virtual machines (VMs) provide. (JAVA is a trademark of the Oracle Corp.) Operating systems may provide breakpoint capability during the execution of application programs, particularly during development or debugging operations. This allows the interruption of the application program at selected locations, namely breakpoints, during execution. Debugger tools may provide extensive breakpoint capability that includes breakpoint generation, breakpoint group management and conditional breakpoints. Debugger tools may provide extensive capability for breakpoint variants, such as watch points and other breakpoint variants. In a multiprocessor and multi-instruction thread processing environment, breakpoint capability may provide designers and other entities with powerful tools during hardware and software development and debugging.

### BRIEF SUMMARY

In one embodiment, the disclosed method includes defining, by a debugger tool, breakpoints in an application. The method also includes generating, by a directed acyclic graph (DAG) tool, a DAG that includes a relational construct of some of the breakpoints including nodes and directed edges. The method further includes executing, by an information handling system (IHS), the application in a debug mode. The method still further includes encountering, by the debugger tool, a particular breakpoint. The method also includes determining, by the DAG tool referencing the DAG, the eligibility of the particular breakpoint for a break/no break decision, wherein logical relationships among breakpoints within the DAG determine eligibility for breakpoint breaking of a particular breakpoint based upon a position of the particular breakpoint within the DAG.

In another embodiment, an information handling system is disclosed that includes a processor and a memory that couples to the processor. The memory includes a debugger tool that is configured to define breakpoints in an application. The memory also includes a directed acyclic graph (DAG) tool that is configured to generate a DAG that includes a relational construct of some of the breakpoints including nodes and directed edges. In one embodiment, the IHS executes the application in a debug mode such that the debugger tool encounters a particular breakpoint in the application. The DAG tool is configured to determine, by referencing the DAG, the eligibility of the particular breakpoint for a break/no break decision, wherein logical relationships among breakpoints within the DAG determine eligibility for breakpoint breaking of a particular breakpoint based upon a position of the particular breakpoint within the DAG.

In yet another embodiment, a computer program product is disclosed that includes a computer readable storage medium. The computer program product includes first program instructions that define breakpoints in an application. The computer program product also includes second program instructions that generate a directed acyclic graph (DAG) that includes a relational construct of some of the breakpoints including nodes and directed edges. The first and second instructions are stored on the computer readable storage medium. In one embodiment, the computer program product includes third program instructions that encounter a particular breakpoint when the IHS executes the application in a debug mode. The computer program product also includes fourth program instructions that determine, by referencing the DAG, the eligibility of the particular breakpoint for a break/no break decision, wherein logical relationships among breakpoints within the DAG determine eligibility for breakpoint breaking of a particular breakpoint based upon a position of the particular breakpoint within the DAG.

### BRIEF DESCRIPTION OF THE DRAWINGS

The appended drawings illustrate only exemplary embodiments of the invention and therefore do not limit its scope because the inventive concepts lend themselves to other equally effective embodiments.

FIG. 1 shows a block diagram of a representative information handling system (IHS) that employs the disclosed DAG breakpoint methodology.

FIG. 2 shows a DAG breakpoint array within an IHS that employs the disclosed DAG breakpoint methodology.

FIG. 3 shows a DAG that a programmer may employ with the disclosed DAG breakpoint methodology.

FIG. 4 depicts a flowchart of an embodiment of the disclosed DAG breakpoint method that provides IHS application DAG breakpoint capability.

FIG. 5 depicts a flowchart of an embodiment of the disclosed DAG breakpoint method that provides more detail of IHS application DAG breakpoint capability.

### DETAILED DESCRIPTION

Information handling systems (IHSs) typically employ operating systems that execute applications or other processes within the IHS. The IHS may include multiple processors, such as processor cores, or other processor elements for application execution and other tasks. The IHS may execute process threads or instructions in an out-of-order sequence as well as employ multiple processors of the IHS during execution. The complexity of IHS application execution provides particular challenges to programmers, designers, and other entities who desire monitoring or debugging of a particular application during execution and testing. Breakpoints provide a powerful feature to allow programmers to break or otherwise halt application execution of an application for a variety of reasons and interrogate a large amount of processing information. The programmer may resume normal application execution after a particular breakpoint operation concludes.

Bugs, problems, faults, or errors in an IHS during execution of a particular application are a significant concern of hardware designers and software programmers. Locating, analyzing, and correcting bugs in an executing IHS application is a process known as “debugging”. Typically a programmer uses a debugger tool or program to debug an application under development and test. Conventional debugger programs typically support two primary operation modes to assist programmers during application debugging. One mode of debugging includes a “step” capability. The step capability permits the programmer to process instructions, threads, or program code one at a time in a sequential and consistent manner. The step capability provides the programmer with access to IHS or processor states, such as register, memory, and other information during execution of each step of the application. The step capability may provide the programmer with a large amount of information for analysis during execution of each instruction of the application.

While this information may be of particular importance and value to a programmer during debugging operations, the large amount of information and step-by-step operations may be tedious and very time consuming. The programmer may step through large numbers of instructions that execute in bug free operation before locating the particular application instruction or code that contains an error. In response to this problem, programmers may exercise a second mode of debugging operation that provides “breakpoint” capability during application execution. Programmers may exercise breakpoint capabilities during application execution at normal clock speeds. Breakpoint debugging capabilities provide an increase in the amount of application execution in a given amount of time over step debugging capabilities.

The programmer may identify, using breakpoint debugging, a precise instruction on which to break or halt execution of the application executing in the IHS. As a result of the breakpoint, the application executes instructions or threads in normal fashion until reaching the breakpoint. The debugger or debugger tool halts execution of the application at the breakpoint and may display or otherwise provide debugging information resources to the programmer or other entity for application and IHS state analysis.

Programmers may use step and breakpoint debugging together to simplify the debugging process. For example, a typical debugging operation sets a breakpoint at the beginning of a particular group of instructions for analysis. Once the application reaches the breakpoint, the application execution halts and the programmer may then perform step-by-step sequencing or stepping through one or more instructions of the particular group of instructions. In this manner, the programmer may analyze a particular group of instructions without the need for single stepping through irrelevant portions of the application.

The programmer may determine particular locations or instructions within the application and set breakpoints at each of these particular locations. Programmers may desire breakpoints at multiple locations within the application. Moreover, the programmer may want to change those multiple breakpoint locations over time, such as during debugging operations. Determining the most effective breakpoint locations, setting those breakpoint locations, and removing and altering the location of these breakpoint locations may be a complex task during application debugging. To make breakpoint setting and removal easier, a debugger may provide breakpoint group setting capabilities. Programmers may form breakpoint groups by selecting common criteria or instruction dependencies for the breakpoints that form the breakpoint group. Breakpoint groups provide programmers the ability to enable and disable groups of breakpoints at the same time.

Breakpoint groups may enable programming tools to more rapidly analyze various aspects of the application operation. For example, breakpoint groups may provide a collection of breakpoints that correspond to memory read or write operations. By selecting the read or write operation breakpoint group either on or off the programmer may focus on or de-focus on that particular aspect of the application execution within the IHS. Many other group criteria are possible for programmers during selection of breakpoint groups.

Application debugging may be more challenging to programmers in a multitasking environment. In a multiple processor and multiple instruction thread or parallel processing environment, breakpoint management may increase dramatically in complexity. For example, multiple instruction threads may require access to common or shared memory locations and overlap or otherwise share memory stores within the IHS. In this case, in order to reduce excessive breakpoint execution, breakpoints that break or halt application operation during memory read or write operations may require more information than just the read or write operation itself.

A debugger tool or debugger program may employ conditional breakpoint capabilities. Conditional breakpoints may provide debuggers and programmers with the ability to halt application program execution if a specific instance, value, or other attribute of the IHS processing state occurs. For example, the application may loop and increment a particular counter during normal operation and a conditional breakpoint may halt application execution when the particular counter reaches a unique value or program variable.

With the increases in application program complexity and similar increases in IHS hardware complexity, breakpoint setting and analysis increase in complexity as well. Programmers benefit from improvements in managing breakpoints by decreasing the time they spend managing and analyzing breakpoints.

In one embodiment of the disclosed directed acyclic graph (DAG) breakpoint methodology, a debugger tool may increase programmer flexibility and improve application debug complexity and time. Programmers may use a directed acyclic graph (DAG) method and tool to arrange or link multiple breakpoints of an application. The DAG method may provide programmers with a useful graphical tool that provides a user-friendly and easily understood construct for breakpoint arrangement and manipulation during application debugging. A DAG is a directed graph with no directed cycles. In other words, the DAG includes a formation of vertices or nodes and directed edges or paths that do not form loops. Stated alternatively, a DAG is a formation of nodes and directed edges that connect from one node to another, such that there is no way to start at one originating node and follow a sequence of directed edges or paths that eventually loop back to the originating node.

A particular node may be a parent node to a child node that receives the directed edge from the particular parent node. In other words, a child node receives the directed edge from a parent node of a DAG. A particular node may be a parent to one node and a child to yet another node at the same time within the same DAG. In the disclosed methodology, designers and programmers may use DAGs to model breakpoints or other processes wherein information flows in a consistent direction through a network of nodes or processors. Programmers or other entities may refer to a DAG as an AND/OR graph as described in more detail below.

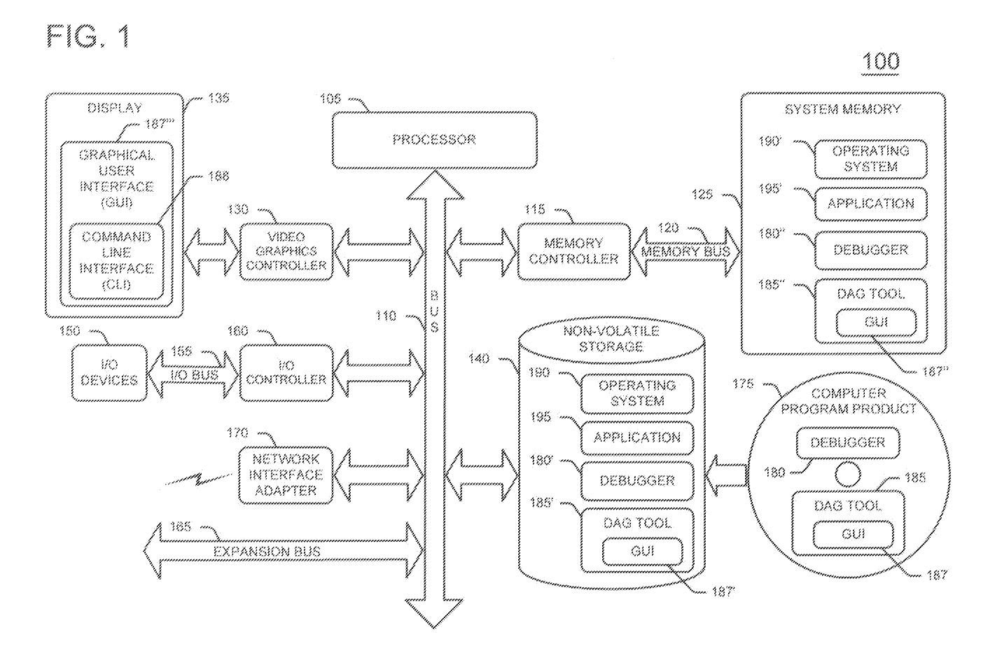

FIG. 1 shows an information handling system 100 with a debugger tool or debugger 180 and a directed acyclic graph (DAG) tool 185 that employs the disclosed DAG breakpoint methodology during execution of an application 195. DAG tool 185 includes a graphical user interface (GUI) 187. IHS 100 includes a processor 105. In one embodiment, processor 105 may include multiple processors cores (not shown). IHS 100 processes, transfers, communicates, modifies, stores or otherwise handles information in digital form, analog form or other form. IHS 100 includes a bus 110 that couples processor 105 to system memory 125 via a memory controller 115 and memory bus 120. In one embodiment, system memory 125 is external to processor 105. System memory 125 may be a static random access memory (SRAM) array or a dynamic random access memory (DRAM) array.

Processor 105 may also include local memory (not shown) such as L1 and L2 caches (not shown). A video graphics controller 130 couples a display 135 to bus 110. Nonvolatile storage 140, such as a hard disk drive, CD drive, DVD drive, or other nonvolatile storage couples to bus 110 to provide IHS 100 with permanent storage of information. I/O devices 150, such as a keyboard and a mouse pointing device, couple to bus 110 via I/O controller 160 and I/O bus 155.

One or more expansion busses 165, such as USB, IEEE 1394 bus, ATA, SATA, PCI, PCIE, DVI, HDMI and other busses, couple to bus 110 to facilitate the connection of peripherals and devices to IHS 100. A network interface adapter 170 couples to bus 110 to enable IHS 100 to connect by wire or wirelessly to a network and other information handling systems. In this embodiment, network interface adapter 170 may also be called a network communication adapter or a network adapter. While FIG. 1 shows one IHS that employs processor 105, the IHS may take many forms. For example, IHS 100 may take the form of a desktop, server, portable, laptop, notebook, netbook, tablet or other form factor computer or data processing system. IHS 100 may take other form factors such as a gaming device, a personal digital assistant (PDA), a portable telephone device, a communication device or other devices that include a processor and memory.

IHS 100 employs an operating system (OS) 190 that may store information on nonvolatile storage 140. IHS 100 includes a computer program product on digital media 175 such as a CD, DVD or other media. In one embodiment, a designer or other entity configures the computer program product with debugger 180 and DAG tool 185 software that includes GUI 187 to practice the disclosed DAG breakpoint methodology. In practice, IHS 100 may store debugger 180, DAG tool 185, GUI 187, OS 190, and application 195 on nonvolatile storage 140 as debugger 180′, DAG tool 185′, GUI 187′, OS 190 and application 195, respectively.

When IHS 100 initializes, the IHS loads debugger 180′, DAG tool 185′, GUI 187′, OS 190 and application 195 into system memory 125 for execution as debugger 180″, DAG tool 185″, GUI 187″, OS 190″ and application 195′, respectively. GUI 187″ ultimately displays on display 135 as GUI 187′″ when DAG tool 185 executes. In accordance with the disclosed methodology, the user may interact with GUI 187′″ on display 135 to manipulate breakpoints and relationships among breakpoints, as discussed in more detail below. GUI 187′″ may include a command line interface (CLI) 188 that provides programmers with command line language interface capability. In one embodiment, IHS 100 may employ OS 190 as a virtual machine (VM) of a virtual machine environment. For example, IHS 100 may employ the JAVA JDK or JRE to enable VM technology.

As will be appreciated by one skilled in the art, aspects of the disclosed DAG breakpoint methodology may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product, such as computer program product 175 embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

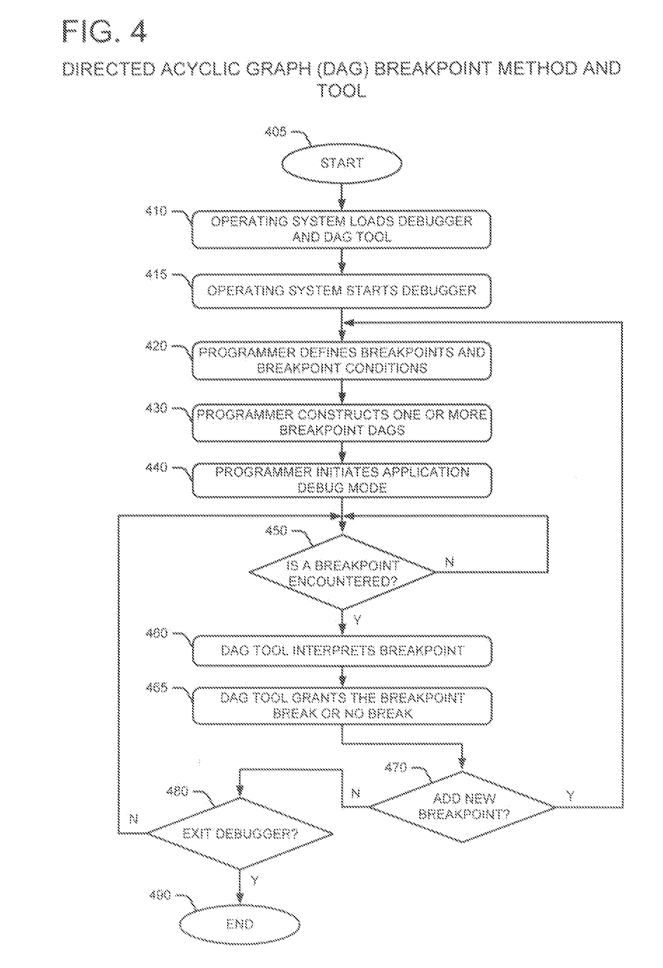

Aspects of the present invention are described below with reference to flowchart illustrations and/or block diagrams of methods, apparatus (systems) and computer program products according to embodiments of the invention. It will be understood that each block of the FIG. 4 flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart of FIG. 4 and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart of FIG. 4 as described below.

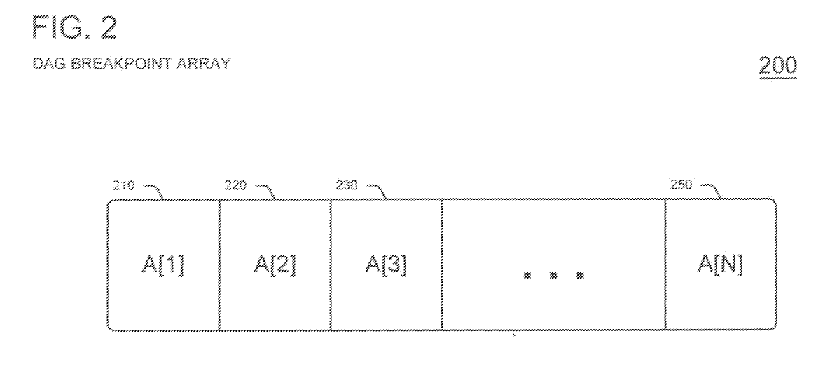

FIG. 2 is a block diagram of a directed acyclic graph DAG breakpoint array 200 that resides in the memory stores of IHS 100, such as system memory 125. DAG breakpoint array 200 may reside in other memory stores (not shown) of IHS 100. DAG breakpoint array 200 stores the respective breakpoint information for each node or vertex of the DAG that a programmer or other entity generates during performance of the disclosed DAG breakpoint method. For example, DAG breakpoint array 200 may include a representative array cell for each DAG breakpoint node that a programmer or other entity generates.

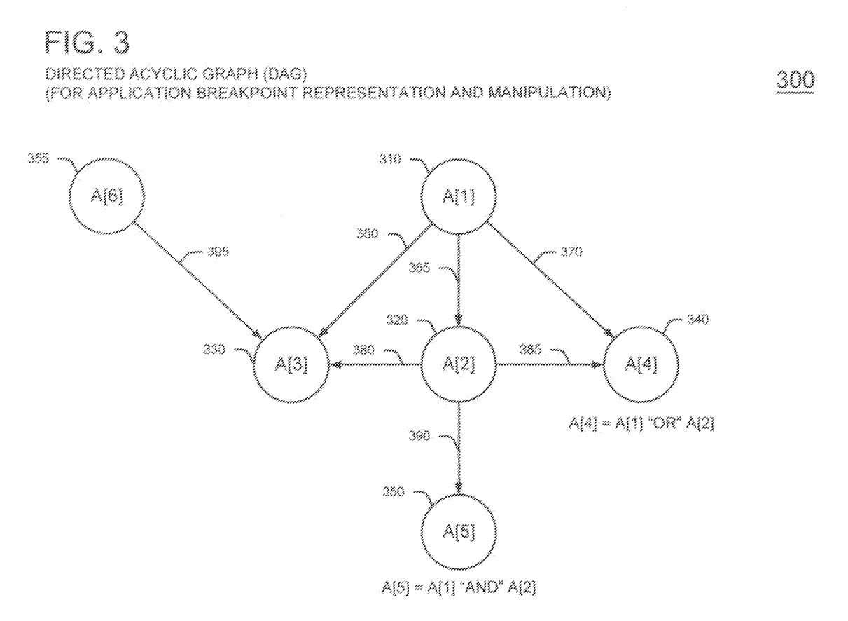

DAG breakpoint array 200 includes an array cell 210 that corresponds to DAG node A[1] breakpoint information. Dag node A[1] breakpoint information and other DAG node breakpoint information will be discussed in more detail with reference to FIG. 3 below. IHS 100 may store DAG information such as shown in DAG breakpoint array 200 using linked lists or other types of linear/non-linear data structures.

DAG breakpoint array 200 cells may contain information, such as a breakpoint and breakpoint position in a particular DAG, such as a DAG 300 described in more detail below with reference to FIG. 3. For example, a particular array cell of DAG breakpoint array 200 of FIG. 2 may correspond to a particular breakpoint in application 195 of FIG. 1 and a particular node in DAG 300 of FIG. 3. DAG breakpoint array 200 array cell data may include parent and child directed edge definitions between particular node and neighboring nodes in DAG 300. DAG breakpoint array 200 data may include conditional breakpoint information as well as other breakpoint information. In one embodiment of the disclosed DAG breakpoint methodology, DAG breakpoint array 200 includes Boolean or other information that describes the execution or breaking of particular breakpoints. The breaking of these particular breakpoints may determine the breaking of other breakpoints in relationship to the particular nodes and corresponding parent/child relationships of neighboring nodes of a DAG, such as DAG 300 described below.

DAG breakpoint array 200 includes an array cell 220 that corresponds to DAG node A[2] breakpoint information. DAG breakpoint array 200 includes an array cell 230 that corresponds to DAG node A[3] breakpoint information. DAG breakpoint array 200 includes an array cell 250 that corresponds to DAG node A[N] breakpoint information, wherein N is the total number of DAG breakpoint array 200 cells. In one embodiment of the disclosed DAG breakpoint methodology, DAG breakpoint array 200 includes the total number N of DAG breakpoint array cells. In another embodiment of the disclosed design, DAG breakpoint array 200 may include any number of DAG breakpoint array 200 cells and corresponding DAG 300 nodes.

The breakpoints that DAG breakpoint array 200 define either break or do not break depending upon the information within the cell of DAG breakpoint array 200 and DAG tool 185 interpretation of a particular DAG construction. The computer science rules of directed acyclic graph (DAG) construction, or DAG construction rules, constrain the generation of DAGs. Whether a breakpoint initiates a break and halts the execution of application 195 or not may depend on the information that resides within the cells of DAG breakpoint array 200. In one embodiment, the breakpoint information in DAG breakpoint array 200 takes into account the relationship of the breakpoint to that of all other breakpoints in DAG breakpoint array 200 and corresponding DAG 300 described below.

FIG. 3 is a diagram of a directed acyclic graph (DAG) 300 for representation and manipulation of application breakpoints. In one embodiment of the disclosed DAG breakpoint methodology, DAG 300 corresponds to the breakpoint information of DAG breakpoint array 200 and moreover the graphical representation of one or more application 195 breakpoints during execution within IHS 100. DAG 300 is a relational execution based breakpoint graphical representation. In one embodiment of the disclosed DAG breakpoint methodology, DAG 300 represents breakpoint management in a JAVA software compiler and debugger environment. In other embodiments, different software environments are possible.

The DAG breakpoint array 200 cells of FIG. 2 above may correspond to nodes or vertices in DAG 300. For example, a node 310 corresponds to array cell 210 of DAG breakpoint array 200 and DAG node A[1] of DAG 300. A node 320 corresponds to array cell 220 of DAG breakpoint array 200 and DAG node A[2] of DAG 300. A node 330 corresponds to array cell 230 of DAG breakpoint array 200 and DAG node A[3] of DAG 300. A node 340 and a node 350, namely DAG node A[4] and DAG node A[5] respectively correspond to other DAG breakpoint array 200 cells (not shown). In one embodiment of the disclosed DAG breakpoint methodology, DAG breakpoint array 200 may include array cells of information for DAG node A[4] and DAG node A[5] respectively.

DAG node A[1] corresponds to a particular breakpoint that may break or otherwise halt execution of application 195. In one embodiment of the disclosed DAG breakpoint methodology, DAG node A[1] corresponds to a particular breakpoint 1 that application 195 may include as breakpoint 1 code within the instructions that debugger 180 and DAG tool 185 manage. As shown below in Table 1, application 195 may include lines of breakpoint code. These breakpoint lines of code may be temporary. In other words, debugger 180 may employ these lines of breakpoint code during debug and disable or otherwise eliminate these from application 195 when not in debug mode.

TABLE 1
Lines of breakpoint code for application 195

Breakpoint code 1
Breakpoint code 2
Breakpoint code 3
Breakpoint code 4
Breakpoint code 5
Breakpoint code 6
Breakpoint code 7

In one embodiment of the disclosed DAG breakpoint methodology, lines of breakpoint code for application 195 include breakpoint code 1, breakpoint code 2, breakpoint code 3, breakpoint code 4, breakpoint code 5, breakpoint code 6, and breakpoint code 7. Each of these breakpoint codes corresponds to a breakpoint that may break or otherwise halt execution of application 195 under proper conditions. Each of the breakpoint lines of code in Table 1 above may be part of a breakpoint group, or other arrangement or sorting of breakpoints.

In one embodiment of the disclosed DAG breakpoint methodology, each of the breakpoints or lines of breakpoint code in Table 1 above corresponds to a respective breakpoint that DAG 300 represents and organizes for debugging purposes of application 195. Referring to DAG 300 of FIG. 3, DAG node A[1] corresponds to breakpoint code 1 of Table 1 above. In other words, DAG node A[1] of DAG 300 represents a particular breakpoint for debugging purposes of application 195. This particular breakpoint is breakpoint code 1, namely breakpoint 1.

DAG nodes A[2], A[3], A[4], A[5] and A[6] correspond respectively to, breakpoint code 2, breakpoint code 3, breakpoint code 4, breakpoint code 5, and breakpoint code 6 of Table 1 above. In other words, DAG nodes A[2], A[3], A[4], A[5], and A[6] of DAG 300 represent particular breakpoints for debugging purposes of application 195. DAG 300 does not employ breakpoint code 7 of Table 1, however breakpoint code 7 may be part of another DAG (not shown) or not part of any other DAG. For example, breakpoint code 6 may represent a conventional breakpoint that works in cooperation with DAG 300 breakpoints under control of debugger 180.

DAG node A[1] or node 310 of DAG 300 directs to DAG node A[3] or node 330 by a directed edge 360. DAG node A[1] directs to DAG node A[2] or node 320 by a directed edge 365. DAG node A[1] directs to DAG node A[4] or node 340 by a directed edge 370. By DAG convention, DAG node A[1] is a parent node to DAG node A[2], DAG node A[3], and DAG node A[4]. By a similar DAG convention, node A[2], DAG node A[3], and DAG node A[4] are each child nodes of DAG node A[1].

DAG node A[2] or node 320 of DAG 300 directs to DAG node A[3] or node 330 by a directed edge 380. DAG node A[2] directs to DAG node A[4] or node 340 by a directed edge 385. DAG node A[2] directs to DAG node A[5] or node 350 by a directed edge 390. By DAG convention DAG node A[2] is a parent node to each of DAG node A[3], DAG node A[4], and DAG node A[5]. By similar DAG convention, DAG node A[3] is a child node of DAG node A[2] and also a child node to DAG node A[1] as mentioned previously. DAG node A[4] is a child node to both DAG node A[2] and DAG node A[1]. DAG node A[5] is a child node of DAG node A[2].

DAG node A[6] or node 355 of DAG 300 directs to DAG node A[3] or node 330 by a directed edge 395. By DAG convention DAG node A[6] is a parent node to DAG node A[3]. By similar DAG convention, DAG node A[3] is a child node of DAG node A[6]. DAG node A[1] and DAG node A[6] are independent nodes. Independent nodes, as shown in FIG. 3, do not have directed edges pointed toward them. Independent nodes may represent independent breakpoints. Debuggers, such as debugger 180 may not require the conditional dependency of any other breakpoint for determining eligibility of an independent breakpoint. However, independent breakpoints may include other conditional factors that debugger 180 interprets during breaking eligibility determination. Independent nodes and their representative independent breakpoints do not have any corresponding dependency nodes or dependency breakpoints. DAG convention constructs parent/child node relationships by definition of those directed edge paths as shown by arrows between the nodes of DAG 300.

In one embodiment of the disclosed DAG breakpoint methodology, OS 190 employs debugger 180 as part of OS 190 during debug operations of application 195. In a similar manner, debugger 180 may employ DAG tool 185 as part of debugger 180 during debug operations of application 195. DAG tool 185 employs GUI 187 as part of DAG tool 185 during debug operations of application 195, and more specifically, during generation and manipulation of DAGs, such as DAG 300. Programmers may perform DAG and debug operations in an integrated development environment (IDE), such as JAVA language oriented Eclipse software or other environment. (Eclipse is a trademark of the Eclipse Foundation.)

DAG 300 represents one example of a directed acyclic graph populated with breakpoint information in the form of nodes and breakpoint relationships. The breakpoint relationships are in the form of directed edges (shown as arrows) or paths. DAG 300 may translate or represent the breakpoint relationships of DAG 300 in the form of AND/OR Boolean relationships. For example, breakpoint code 5 that corresponds to DAG node A[5] is subject to the DAG tool 185 interpretation of DAG node A[1] (breakpoint code 1) AND DAG node A[2] (breakpoint code 2). In other words, stated in a Boolean fashion, DAG 300 represents node 350 as equal to node 310 “AND” node 320. In this manner, DAG tool 185 determines one factor relating to the execution eligibility of a particular breakpoint by first determining the relationship of that particular breakpoint to each other breakpoint within DAG 300. In one embodiment, DAG tool 185 determines a particular breakpoint relationship to those other breakpoints of DAG 300 that direct by directed edges from a parent breakpoint to that particular breakpoint.

To further describe the full Boolean expression for the breakpoint relationship of DAG node A[5], DAG tool 185 or other entity examines each directed edge of the parent node, namely DAG node A[2] of DAG node A[5]. For example, the full Boolean expression for the breakpoint relationship of DAG node A[5] equals DAG node A[1] “AND” DAG node A[2] and “NOT” DAG node A[3] and “NOT” DAG node A[4]. In other words, the directed edges of DAG node A[2] may describe a parent node or lack of a parent node that DAG tool 185 determines for qualification of a particular breakpoint execution eligibility. Looking at another case, the breakpoint relationship for DAG node A[4] is equal to DAG node A[1] “OR” DAG node A[2]. Both DAG node A[1] and DAG node A[2] are parent nodes of DAG node A[4] and thus contribute determining factors for DAG tool 185 to evaluate during eligibility evaluation of breakpoint code 4 corresponding to DAG node A[4].

To further describe the Boolean expressions for breakpoint relationships of DAG 300, DAG 300 represents node 330 as equal to node 355 “OR” node 310. In other words, DAG node A [3] equals DAG node A[6] OR DAG node A[1]. In another expression, node 330 is equal to node 310 “OR” node 320. In other words, DAG node A [3] equals DAG node A[1] OR DAG node A[2]. Node 330 is also equal to node 355 “OR” node 320. In other words, DAG node A [3] equals DAG node A[6] OR DAG node A[2]. DAG 300 may express other Boolean relationships between nodes as shown in FIG. 3 consistent with DAG conventions. Again, DAG nodes A[1] and A[6] are independent nodes in the above Boolean relationships since these nodes do not depend on the breakpoints of any other nodes.

DAG tool 185 may interpret and determine the eligibility for execution of any breakpoint that has a corresponding node within DAG 300. For example, in one case, application 195 reaches a breakpoint such as breakpoint code 5 during debugging operations. In this case, debugger 180 employs DAG tool 185 during execution of application 195 in debug mode. DAG tool 185 evaluates the information regarding breakpoint code 5 that resides within DAG breakpoint array 200 and corresponding DAG 300. DAG 300 represents breakpoint code 5 as DAG node A[5] or node 350. DAG tool 185 performs a relationship test for breakpoint code 5 by evaluating the previous execution status of any parent node to DAG node A[5]. In this case DAG node A[2] is a parent node to DAG node A[5]. DAG tool 185 determines if breakpoint code 5 is eligible to break by determining if breakpoint code 2 that corresponds to DAG node A[2] has already executed a break operation.

DAG tool 185 evaluates the true or false status of DAG node A[2] corresponding to breakpoint code 2. If DAG node A[2] is “true” then breakpoint code 2 has already executed. If DAG node A[2] is “false” then breakpoint code 2 has not previously executed. DAG tool 185 may determine a particular breakpoint of DAG 300 as true or false by interrogating DAG breakpoint array 200 or in a separate hash table (not shown) for that particular node. A hash table may reside in system memory 125 or other memory store of IHS 100 during execution and debugging of application 195. A hash table is a memory or data structure that employs a hash function to map identifying values, such as true/false breakpoint execution values to a particular function, such as that of the breakpoint code number, in this case that of breakpoint code 2. DAG tool 185 may read hash table information (not shown) or DAG breakpoint array 200 to determine if a particular breakpoint did execute or did not execute at any point during debugger 180 or application 195 operation.

In one embodiment of the disclosed DAG breakpoint methodology, DAG 300 employs a list or store of parent nodes indexed in DAG breakpoint array 200 for each node of DAG 300. DAG breakpoint array 200 may also include conditional breakpoint information and the Boolean expressions as shown in the graphical representation of DAG 300 nodes and directed edge data. DAG breakpoint array 200 may also include parent node information along with prior execution true/false status of each parent node. In one embodiment of the disclosed DAG breakpoint methodology, DAG breakpoint array 200 may not require child node information for analysis by DAG tool 185 during breakpoint eligibility determination.

In one embodiment of the disclosed DAG breakpoint methodology, a programmer may generate DAG 300 using the DAG breakpoint array 200 as a store for DAG breakpoint information. In other words, a programmer or other entity may generate acyclic graphical relationships and breakpoint information and store that information into DAG breakpoint array 200 to generate a representative DAG 300 as shown in FIG. 3. In another embodiment of the disclosed methodology, a programmer may use a graphical interface, such as graphical user interface GUI 187′″ in IHS 100 to graphically construct DAG 300 as shown in FIG. 3. For example, a programmer may click and drag nodes and directed edges as shown in DAG 300 on a user interface and store that representation of DAG 300 as information into DAG breakpoint array 200. In this manner a programmer may perform relatively straightforward graphical manipulations of breakpoint insertion, positioning, and corresponding parent/child relationship changes prior to or during execution and debug of application 195. FIG. 3 thus provides an example of a graphical user interface (GUI) that is useful as GUI 187′″ to enable a user to manipulate the topology of DAG 300.

Software class breakpoints may belong to instructions, threads, or code that corresponds to a particular software class. Software classes are common features of object-oriented programming. A class is a construct that operating systems, compilers, and other programs employ as a template to create objects of a particular class. An object of a given class is known as an instance of the given class. OS 190 may generate multiple instances of software class breakpoints during multi-tasking operations of application 195 within IHS 100.

These software class breakpoints may execute at each instance that application 195 generates during execution. Programmers may avoid multiple instances by conditioning the software class breakpoints to halt application execution at particular instances and by-pass or not halt at other instances. This conditioning is a form of conditional breakpoint operation. This conditioning or conditional information may reside within DAG breakpoint array 200, or other memory stores of IHS 100.

In one embodiment of the disclosed DAG breakpoint methodology, DAG tool 185 employs a historical approach to breakpoint eligibility determination. For example, each particular node of DAG 300 is conditioned upon the execution or true/false state of the particular node's respective parent node. A particular parent node may be conditioned upon that particular parent node's respective parent node, and so forth. In this manner, DAG tool 185 maintains a history of parent/child relationships. This parent/child relationship, as shown in DAG 300, may provide DAG tool 185 with input into breakpoint eligibility determination.

Programmers may group the execution of breakpoints based on a particular defect or defect area that occurs during application 195 execution. For example, programmers may group breakpoints that correspond to register read or write operations, memory accesses, load/store commands, or other types of application 195 instruction operations and potential defect areas. Programmers may employ DAG 300 to generate relational breakpoint eligibility models or tools during application 195 debug. The programmer may employ DAG tool 185 and DAG 300 to skip particular breakpoints during application 195 debug. The programmer may also change breakpoint eligibility status by modifying or manipulating DAG 300 during runtime of application 195. The programmer employs GUI 187′″ of display 135, and GUI 187 of DAG tool 185 as an interface for this dynamic manipulation of DAG 300 to manipulate of breakpoint eligibility.

In one embodiment of the disclosed DAG breakpoint methodology, a programmer may generate or modify DAG 300 through command line operations. For example, using graphical user interfaces, such as GUI 187′″, the programmer may enter breakpoint information as well as the construct of DAG 300 using command line language. The programmer may use command line language by employing GUI 187′″ as the command line interface CLI 188 that communicates directly with DAG tool 185. In other words, the programmer may enter DAG construct language in cooperation with DAG tool 185 to generate the information within DAG breakpoint array 200 and thereby generate corresponding DAG 300.

In another embodiment of the disclosed DAG breakpoint method, a programmer may graphically generate DAG 300 from GUI 187′″ or other user interface tools (not shown) of IHS 100. For example, the programmer may review breakpoint code, such as the “lines of breakpoint code for application 195” of Table 1 above on a display, such as on display 135. The programmer may employ DAG tool 185 in cooperation with GUI 187′″ to graphically select a particular breakpoint or breakpoint code with a mouse pointer or other pointing or selection device or method.

The programmer may move the breakpoint code selection onto an area of display 135 for DAG construction. For example the programmer may select breakpoint code 1 as shown in Table 1 above and move, or point that breakpoint information onto display 135 for DAG 300 construction. In this manner, the programmer graphically generates node 310 or DAG node A[1] as shown in FIG. 3. DAG tool 185 may automatically generate corresponding information in DAG breakpoint array 200 to further support the DAG 300 display. The programmer may continue selecting breakpoint code, such as breakpoint code 2, breakpoint code 3, breakpoint 4, breakpoint 5, and breakpoint 6 and graphically generating the remaining nodes of DAG 300 as node 320, node 330, node 340, node 350, and node 355 respectively.

In a similar manner, the programmer may construct directed edges, such as directed edge 360 by pointing and dragging an arrow or pointer from node 310 to node 330. In this manner, the programmer generates a directed edge from DAG node A[1] as the parent node, to DAG node A[3] as the child node of that relationship. The programmer may graphically generate an arrow from node 310 to both node 320 and node 340 thereby generating directed edge 365, and directed edge 370 respectively. The programmer may generate an arrow from node 320 to node 330 and to node 340 thereby generating directed edge 380 and directed edge 385 respectively. Using GUI 187′″ of IHS 100, the programmer may generate an arrow from node 320 to node 350 thereby generating directed edge 390.

In one embodiment of the disclosed DAG breakpoint methodology, DAG tool 185 detects and stops the attempted generation of cyclic graphical dependencies during generation of DAG 300. In other words, if a user, programmer, or other entity attempts to generate a structure within a DAG that includes a pathway that loops back upon any particular node, DAG tool 185 will not allow that DAG generation in keeping with the construction constraints of acyclic graphs. Stated in another way, DAG tool 185 detects and blocks the attempted generation of non acyclic graph relationships during the generation of DAGs. The programmer may store DAG 300, or other DAG constructs within IHS memory, such as system memory 125 or other stores. In this manner, the programmer may make a copy of DAG 300 and transfer that DAG to another storage media within IHS or outside of IHS to employ on other IHSs or at a future time within IHS 100.

Breakpoint code 6 of Table 1 is not a part of DAG 300. Breakpoint code 6 may not be part of any other DAG as well. In this case, breakpoint code 6 is a non-DAG breakpoint. Debugger 180 may manage breakpoint code 6 and other non-DAG breakpoint code that is not part of any DAG construct. In this case, debugger 180 manages breakpoint code 6 and any other non-DAG breakpoints by breaking each non-DAG breakpoint when application 195 encounters such breakpoints during normal runtime debug operation.

The flowchart of FIG. 4 illustrates the architecture, functionality, and operation of possible implementations of systems, methods and computer program products that perform data packet management in accordance with various embodiments of the present invention. In this regard, each block in the flowchart of FIG. 4 may represent a module, segment, or portion of code, which comprises one or more executable instructions for implementing the specified logical function(s). It should also be noted that, in some alternative implementations, the functions noted in the block may occur out of the order noted in FIG. 4. For example, two blocks shown in succession may, in fact, be executed substantially concurrently, or the blocks may sometimes be executed in the reverse order, depending upon the functionality involved. It will also be noted that each block of FIG. 4 and combinations of blocks in the block diagrams and/or flowchart illustration, can be implemented by special purpose hardware-based systems that perform the specified functions or acts, or combinations of special purpose hardware and computer instructions.

FIG. 4 is a flowchart that shows process flow in an embodiment of the disclosed DAG breakpoint methodology that provides DAG breakpoint management in an IHS. More specifically, the flowchart of FIG. 4 shows how DAG tool 185 that debugger 180 may employ provides for management of breakpoints of application 195 before and during execution of application 195. Moreover, GUI 187 of DAG tool 185 provides programmers with user interface capability to manipulate relative positioning and interaction of application 195 breakpoints. Programmers may use GUI 187′″ to generate a representative DAG, such as DAG 300, before and during execution of application 195 in debug mode. The disclosed DAG breakpoint method starts, as per block 405.

In one embodiment, operating system OS 190 loads debugger 180 and DAG tool 185, as per block 410. OS 190 may load debugger 180 and DAG tool 185 into system memory 125 during execution of application 195 in IHS 100. In this manner, programmers gain access to breakpoints of application 195 through GUI 187′″ or by other methods. Application 195 may execute within IHS 100 without breakpoint breaks, for example without debugger 180, application 195 may execute essentially ignoring all breakpoint code. In one embodiment of the disclosed DAG breakpoint methodology, debugger 180 must execute in order to initiate breakpoint operations. OS 190 starts debugger 180, as per block 415. In this manner, all breakpoint code within application 195 operates in debug mode. In other words, breakpoints will break as a programmer or other entity directs by manipulation of breakpoint code, breakpoint conditional attributes, breakpoint dependencies, or other breakpoint control.

A programmer defines breakpoints and breakpoint conditions, as per block 420. In other words, during execution of application 195, a programmer or other entity may add, remove, or otherwise modify existing breakpoint code within or corresponding to application 195. The programmer may define conditional dependencies for any particular breakpoint and store that breakpoint information in application 195 or other memory stores of IHS 100, for example in DAG breakpoint array 200. The programmer constructs one or more breakpoint DAGs, as per block 430. For example, the programmer may use GUI 187′″ to organize, move, generate or otherwise manipulate breakpoints of application 195 into a DAG, such as DAG 300.

The programmer may generate multiple DAGs that operate in cooperation with each other during execution of application 195 and during debugging operations. In one embodiment of the disclosed DAG breakpoint method, the programmer employs DAG tool 185 to generate multiple DAGs that may include the same breakpoint or breakpoint instance. In the case wherein more than one DAG includes a particular breakpoint, DAG tool 185 may make a combined eligibility decision by interpreting each multiple breakpoint instance of the particular breakpoint independently or collectively. A combined eligibility decision considers a collection of relevant breakpoint instances in multiple DAGs. During eligibility determination for a particular breakpoint, DAG 185 may include any combination of the particular breakpoint instances for one or more DAGs that include that breakpoint. In one embodiment, the programmer controls the rules that govern multiple DAG and multiple breakpoint instances as part of GUI 187″. In one embodiment, the DAG tool 185 considers conditions of at least one of the DAGS that includes the particular breakpoint. In another embodiment, the DAG tool 185 considers conditions of all of the DAGs that include the particular breakpoint.

The programmer initiates application debug mode, as per block 440. In other words, during execution of application 195 in IHS 100, the programmer may initiate the execution of debugger 180 and DAG tool 185 to provide breakpoint management tools to the programmer. During debug mode, breakpoints may break and either halt or not halt execution of application 195. Debugger 180 tests to determine if debugger 180 encounters a breakpoint, as per decision block 450. If debugger 180 does not encounter a breakpoint during execution of application 195 code, debugger 180 continues testing for breakpoint encounters. However, if debugger 180 encounters a breakpoint, DAG tool 185 interprets the breakpoint, as per block 460.

DAG tool 185 governs the eligibility of a particular breakpoint to either break or not break depending upon the directed acyclic relationship of the particular breakpoint to neighboring breakpoint nodes as shown in DAG 300 of FIG. 3. DAG tool 185 first interprets the particular breakpoint by determining if the breakpoint encounter is a breakpoint that resides within an existing DAG, such as DAG 300. For example, as part of the interpretation, only those breakpoints that reside within a DAG require further DAG tool 185 interpretation. Other breakpoints may operate within application 195 by employing debugger 180 conventional non-DAG operations.

DAG tool 185 examines the encountered breakpoint and determines if the encountered breakpoint should break or not break from the rules of DAG construction and more particularly, the information that DAG 300 contains. DAG tool 185 either grants breakpoint break or no break, as per block 465. For example, referring to FIG. 3, if the encountered breakpoint is breakpoint A[2], DAG tool 185 first determines if breakpoint A[1] is true as described in more detail above. If breakpoint A[1] is true, then DAG tool 185 allows breakpoint A[2] to either break or not break depending upon conditional dependencies of breakpoint A[2]. However, if breakpoint A[1] is false, then DAG tool 185 does not allow breakpoint A[2] to break. In this manner, DAG tool 185 restricts the actions of any particular encountered breakpoint to the rules of DAG construction and the relational structure of the encountered breakpoint within the DAG.

During normal operation of debugger 180 and DAG tool 185, the programmer may make changes to a particular DAG, such as DAG 300 while application 195 executes. The programmer may add a new breakpoint, as per block 470. If the programmer or other entity adds a new breakpoint, the programmer defines the breakpoint and breakpoint conditions and flow continues again, as per block 420. In one embodiment of the disclosed DAG breakpoint methodology, the programmer may add, remove, or otherwise manipulate breakpoints of DAG 300 dynamically or during run time execution of application 195. If the programmer does not add a new breakpoint to DAG 300 or other DAG, OS 190 tests to determine if the programmer exits the debugger, as per decision block 480. If the programmer does not exit the debugger, such as exiting debug mode, then debugger 180 continues testing for breakpoint encounters, as per block 450. However, if the programmer exits the debugger, then the disclosed DAG breakpoint method ends, as per block 490.

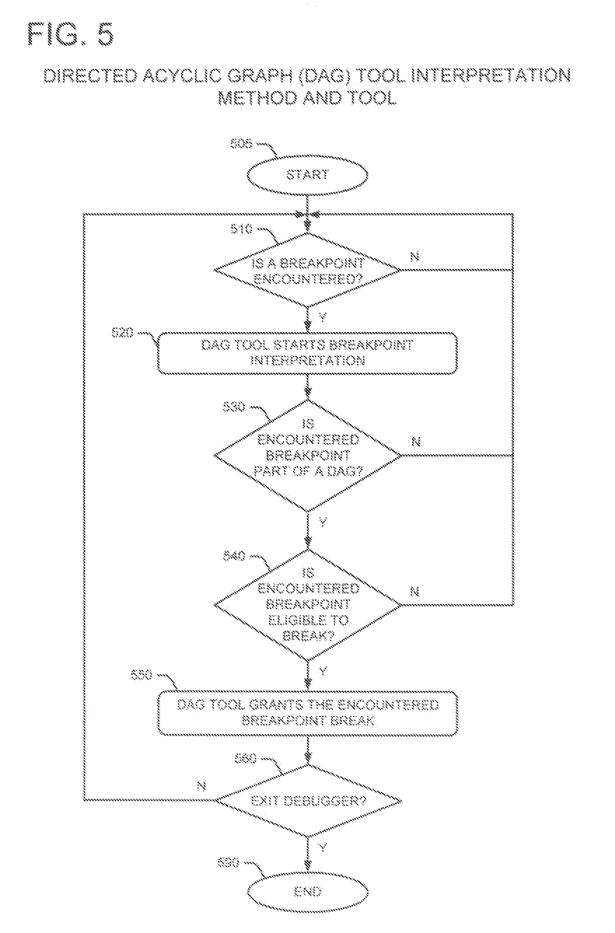

FIG. 5 is a flowchart that shows process flow in an embodiment of the disclosed DAG breakpoint methodology in which DAG tool 185 provides interpretation of breakpoint eligibility for breaking. DAG tool 185 eligibility interpretation as shown in the flowchart of FIG. 5 provides more detail to the DAG tool interpreting step, namely block 460 of the flowchart of FIG. 4. As shown in FIG. 5, the more detailed DAG tool interpretation method starts, as per block 505. Debugger 180 determines if a breakpoint is encountered, as per decision block 510. If debugger 180 does not encounter a breakpoint, then testing continues for a breakpoint encounter during debug mode. However, if debugger 180 encounters a breakpoint, then DAG tool 185 starts breakpoint interpretation, as per block 520.

As part of breakpoint interpretation, DAG tool 185 determines if the encountered breakpoint is part of one or more DAGs, such as DAG 300 or other DAG (not shown), as per decision block 530. If the encountered breakpoint is not part of any DAG, then debugger 180 continues testing for encountered breakpoints again per block 510. However, if the encountered breakpoint is part of a DAG, such as DAG 300, DAG tool 185 perform testing to determine if the encountered breakpoint is eligible to break, as per decision block 540.

In one embodiment of the disclosed DAG breakpoint method, programmers or other entities may select DAG breakpoint eligibility criteria prior to encountering breakpoints during application 195 debug. For example, programmers may provide selection criteria that require the encountered breakpoint to be part of one and only one DAG in order for DAG tool 185 to continue further breakpoint eligibility determination. In other cases, programmers may provide selection criteria that require encountered breakpoints to be part of more than one, or any combination of existing DAGs for breakpoint eligibility determination by DAG tool 185. If DAG tool 185 does not determine that the encountered breakpoint is eligible for breaking, debugger 180 continues testing for encountered breakpoints, again per block 510. However, if DAG tool 185 determines that the encountered breakpoint is eligible to break, DAG tool 185 grants or approves the encountered breakpoint break, as per block 550.

If DAG tool 185 grants or approves the encountered breakpoint break, debugger 180 tests to determine if the programmer indications a selection to exit the debugger, as per decision block 560. If the programmer does not exit the debugger to end the debug mode, then debugger 180 continues in debug mode to test for breakpoint encounters, as per block 510. However, if the programmer exits the debugger at decision block 560, then the disclosed DAG tool interpretation method ends, as per block 590.

As will be appreciated by one skilled in the art, aspects of the disclosed DAG breakpoint management technology may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method, comprising:
defining, by a debugger tool in an information handling system (IHS), breakpoints in an application; and
generating, by a directed acyclic graph (DAG) tool in the IHS, a DAG that includes a relational construct of some of the breakpoints including nodes and directed edges, wherein logical relationships among breakpoints within the DAG determine eligibility for breakpoint breaking of a particular breakpoint based upon a position of the particular breakpoint within the DAG.

2. The method of claim 1, further comprising:
executing, by the (IHS), the application in a debug mode;
encountering, by the debugger tool, the particular breakpoint;
determining, by the DAG tool referencing the DAG, the eligibility of the particular breakpoint for a break/no break decision.

3. The method of claim 2, further comprising:
performing a break, by the debugger tool, at the particular breakpoint dependent on the break/no break decision for the particular breakpoint.

4. The method of claim 1, wherein the DAG tool includes one of a graphical user interface (GUI) and a command line interface to manipulate breakpoint relationships in the DAG.

5. The method of claim 1, further comprising:
manipulating, by a user, the DAG at application run time to change relationships among breakpoints.

6. The method of claim 1, wherein the generating step further comprises:
storing, by the DAG tool, DAG information in a DAG breakpoint array.

7. The method of claim 1, further comprising:
blocking, by the DAG tool, an attempt to make a cyclic relationship in the DAG.

8. The method of claim 1, wherein the determining step further comprises the DAG tool determining the eligibility of the particular breakpoint for a break/no break decision by referencing a plurality of DAGs.

9. An information handling system (IHS), comprising:
a processor; and
a memory, coupled to the processor,
the memory including a debugger tool that is configured to define breakpoints in an application;
the memory including a directed acyclic graph (DAG) tool that is configured to generate a DAG that includes a relational construct of some of the breakpoints including nodes and directed edges, wherein logical relationships among breakpoints within the DAG determine eligibility for breakpoint breaking of a particular breakpoint based upon a position of the particular breakpoint within the DAG.

10. The IHS of claim 9, wherein the IHS executes the application in a debug mode such that the debugger tool encounters the particular breakpoint in the application, the DAG tool being configured to determine, by referencing the DAG, the eligibility of the particular breakpoint for a break/no break decision.

11. The IHS of claim 10, wherein the DAG tool is further configured to perform a break at the particular breakpoint dependent on the break/no break decision for the particular breakpoint.

12. The IHS of claim 9, wherein the DAG tool includes one of a graphical user interface (GUI) and a command line interface to manipulate breakpoint relationships in the DAG.

13. The IHS of claim 9, wherein the DAG tool is further configured to enable a user to manipulate the DAG at application run time to change relationships among breakpoints.

14. The IHS of claim 9, wherein DAG tool is further configured to store DAG information in a DAG breakpoint array.

15. The IHS of claim 9, wherein DAG tool is further configured to block an attempt to make a cyclic relationship in the DAG.

16. The method of claim 10, wherein the DAG tool is configured to analyze the eligibility of breakpoints for breaking across a plurality of DAGs.

17. A computer program product, comprising:
a computer readable storage medium;
first program instructions that define breakpoints in an application; and
second program instructions that generate a directed acyclic graph (DAG) that includes a relational construct of some of the breakpoints including nodes and directed edges, wherein logical relationships among breakpoints within the DAG determine eligibility for breakpoint breaking of a particular breakpoint based upon a position of the particular breakpoint within the DAG;
wherein the first and second instructions are stored on the computer readable storage medium.

18. The computer program product of claim 17, further comprising:
third program instructions that encounter a particular breakpoint when the IHS executes the application in a debug mode;
fourth program instructions that determine, by referencing the DAG, the eligibility of the particular breakpoint for a break/no break decision.

19. The computer program product of claim 18, further comprising:
fifth program instructions that perform a break at the particular breakpoint dependent on the break/no break decision for the particular breakpoint.

20. The computer program product of claim 17, further comprising
sixth program instructions that provide a graphical user interface (GUI) to manipulate breakpoint relationships in the DAG.
